(19) United States
(12) Patent Application Publication
(10) Pub. No.: US 2006/0249031 A1
(43) Pub. Date: Nov. 9, 2006

(54) Camping popcorn popper

(75) Inventors: Norris Richard Long, Wichita, KS (US); Robert L. Lawhon, Andover, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6780, US

(73) Assignee: The Coleman Company, Inc., Wichita, KS (US)

(21) Appl. No.: 11/122,927

(22) Filed: May 5, 2005

(51) Int. Cl. A23L 1/18

(52) U.S. Cl. 99/323.5

(57) ABSTRACT

A camping popcorn popper that is portable and may be taken, for example, to a campsite for use while camping. In an embodiment, the camping popcorn popper includes a housing and a burner assembly for burning fuel, the burner assembly being at least partly mounted within the housing. A cooking pot is mounted above the burner assembly and is used for heating popcorn kernels. A chute is provided for directing popcorn kernels flowing out of the cooking pot away from the cooking pot.

### TECHNICAL FIELD OF THE INVENTION

The present invention relates to appliances, and more particularly, fuel burning appliances.

### BACKGROUND OF THE INVENTION

Camping is a popular recreational activity enjoyed by many. Some people camp so that they may enjoy the outdoors, and others use camping as an inexpensive alternative to staying in hotels.

Although many campers enjoy being in the outdoors, often campers like to enjoy the luxuries of home while camping. For example, many campers bring lounges chairs or hammocks, portable air mattresses or cots, and similar items to make the camping experience more comfortable and more like home.

One item that is difficult to enjoy while camping is popcorn. At home, a user may use a microwave or a countertop popcorn maker, but AC power is seldom available when camping.

At present, making popcorn over a flame, for example on a camping stove or over the fire, is difficult. The process is imprecise, and the user risks burning the popcorn and having a large number of un-popped kernels.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a camping popcorn popper is provided that is fully portable and may be taken, for example, to a campsite for use while camping. In an embodiment, the camping popcorn popper includes a housing and a burner assembly for burning fuel, the burner assembly being at least partly mounted within the housing. A cooking pot is mounted above the burner assembly and is used for heating popcorn kernels. A chute is provided for directing popcorn kernels flowing out of the cooking pot away from the cooking pot.

In accordance with an embodiment, the burner assembly is fully contained within the housing. To provide airflow for the burner assembly, the housing may include upper and lower vents for permitting airflow to the burner assembly. The housing may be shaped so as to serve as a wind block for the burner assembly.

In an embodiment, the cooking pot is mounted to the chute and the chute is rotatably connected to the housing so that the chute may be tilted to empty popped popcorn kernels out of the chute. A stirrer may be provided to stir popcorn kernels within the cooking pot. In an embodiment, the stirrer is manually actuated (e.g., rotated). In another embodiment, the stirrer is mounted to the popcorn chute. In yet another embodiment, the stirrer is flexibly mounted in the cooking pot so that the stirrer is capable of moving to roll over a popcorn kernel in the cooking pot.

In accordance with an embodiment, a regulator assembly is attached to the burner assembly and is rotatably mounted to the housing so that it may be stored relative to the housing, for example in a recess.

In accordance with another embodiment, a popcorn popper is provided having a burner assembly for burning fuel and a cooking pot mounted above the burner assembly. The cooking pot includes a trough along a bottom of the cooking pot, the trough aligned at least in part with the flame pattern of the burner assembly.

In an embodiment, the trough is shaped as a circle. The circle may be concentric with the center of the bottom of the cooking pot. In an embodiment, the trough is substantially aligned with the flame pattern.

Other features of the invention will become apparent from the following detailed description when taken in conjunction with the drawings, in which:

### BRIEF DESCRIPTION OF THE DRAWINGS

FIG. 1 is a right, front side perspective view of a camping popcorn popper in accordance with an embodiment of the invention;

FIG. 2 is a right, rear side perspective view of the camping popcorn popper of FIG. 1;

FIG. 3 is a left, front side perspective view of the camping popcorn popper of FIG. 1;

FIG. 4 is a right, rear perspective view of the camping popcorn popper of FIG. 1, with a regulator assembly folded to a stored position in accordance with an embodiment of the invention;

FIG. 5 is an exploded side perspective view of the camping popcorn popper of FIG. 1;

FIG. 6 is a sectional view of the camping popcorn popper of FIG. 1, with parts removed for detail;

FIG. 7 is a sectional view of a top portion of the camping popcorn popper of FIG. 1;

FIG. 8 is a partial cut-away view of a portion of the camping popcorn popper of FIG. 1, showing an agitator or stirrer assembly in accordance with an embodiment;

FIG. 9 is a side perspective view of an alternate embodiment of a camping popcorn popper in accordance with an embodiment of the invention;

FIG. 10 is a perspective sectional view of a pot used with the camping popcorn popper of FIG. 9;

FIG. 11 is an exploded side perspective view of the camping popcorn popper of FIG. 10; and

FIG. 12 is a sectional view of the camping popcorn popper of FIG. 9.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

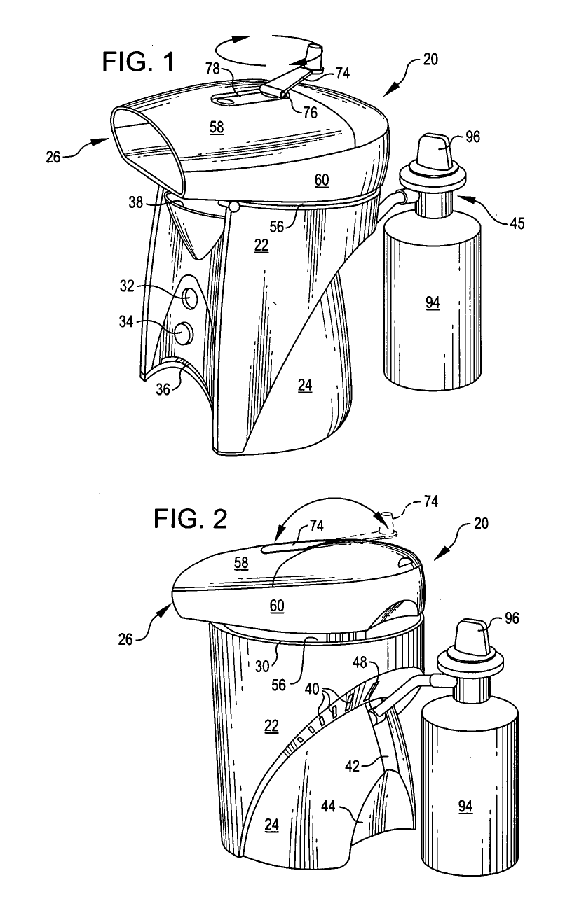

Referring now to the drawings, in which like reference numerals represent like parts throughout the several views, FIG. 1 shows a camping popcorn popper 20 in accordance with an embodiment of the present invention. The camping popcorn popper 20 includes an upper housing 22 situated over a lower housing 24. A popcorn chute 26 is arranged over the upper housing 22. In accordance with an embodiment, the camping popcorn popper 20 is fully portable and may be taken, for example, to a campsite for use while camping.

The upper and lower housings 22, 24 are preferably formed of plastic, such as BAKELITE plastic, but other materials may be used. Similarly, the chute 26 is also preferably formed of plastic.

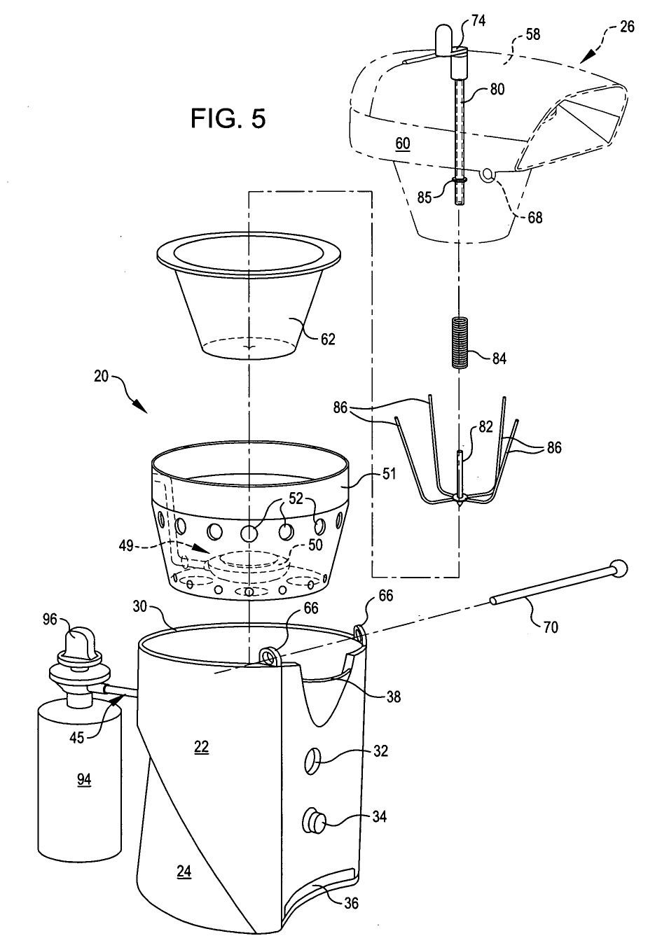

As can be seen in FIG. 5, the upper housing 22 includes an upper opening 30. A front side of the upper housing 22 is concave so that a round container (not shown) may be placed close to the camping popcorn popper 20 so that the container may catch popcorn exiting the chute 26. A view port/match hole 32 is positioned about halfway up the front side of the upper housing 22. An electronic ignition button 34 is located below the view port/match hole 32. A lower vent 36 is positioned at a bottom of the front of the upper housing 22. An upper vent 38, shaped as a convex protrusion, is positioned at a front, top portion of the upper housing 22.

The lower housing 24 may include feet (not shown) or another structure so that the camping popcorn popper 20 may be positioned on a suitable surface, such as a table top. As can be seen in FIG. 2, the lower housing 24 includes upper vents 40 positioned on a downward facing, slanted portion of the lower housing and arranged so as to promote good flow of air into the camping popcorn popper 20, but to prevent rain from entering the upper and lower housings 22, 24. Additional vents may be provided on the lower housing 24, for example on a bottom of the housing (not shown).

As can be seen in FIG. 4, the lower housing 24 includes a rear recess 44 at a bottom portion of the lower housing. A rear slot 42 extends from the rear recess up toward a top of the lower housing 24.

A regulator assembly 45 is attached to the back of the lower housing 24. The regulator assembly 45 includes a regulator 46 attached to a stem 47. The stem 47 is connected to a rotary connection 48. The rotary connection permits the regulator assembly 45 to be rotated from the position shown in FIG. 2 to the position shown in FIG. 4 for storage of the regulator assembly within the rear recess 44 and the rear slot 42. The rotary connection 48 is connected to a burner assembly 49 and is configured so that fuel from the regulator 46 does not leak at the rotary connection 48 regardless of rotation of the regulator assembly 45 or the position of the regulator assembly 45 with respect to the lower housing 24. Such rotary connections are known in the art of fuel lines, and detail is not given here.

The burner assembly 49 leads to a burner 50 (shown in phantom in FIG. 5). The burner 50 is mounted at the bottom of a fire pan 51. The fire pan 51 is preferably a metal or other suitable fireproof material, and includes a number of vent holes 52 which allow the mixing of fuel and air. The fire pan 51 is mounted on a shelf 54 within the upper housing 22 or in another position within the upper or lower housings 22, 24. Space is provided around the perimeter of the fire pan 51 for the adequate circulation of air.

As can be seen in FIGS. 2 and 4, a gap 56 exists between the chute 26 and the upper opening 30 of the upper housing 22. This gap 56 permits combustion gases and air to flow out of the top of the upper housing 22.

As can be seen, the upper and lower housings 22, 24 are designed to promote air flow through the camping popcorn popper 20. The gap 56, the lower vent 36, and the upper vent 38 of the upper housing 22, and the upper vents 40 and other vents provided in the lower housing 24 provide significant air flow through the camping popcorn popper 20, yet do not permit rain to enter the upper and lower housings. As such, sufficient air for combustion at the burner 50 is provided, and the burner 50 is protected from rain. In addition, the vents and openings are arranged so that the upper and lower housings 22, 24 provide a wind block for the burner 50, permitting the camping popcorn popper to be operated in windy conditions.

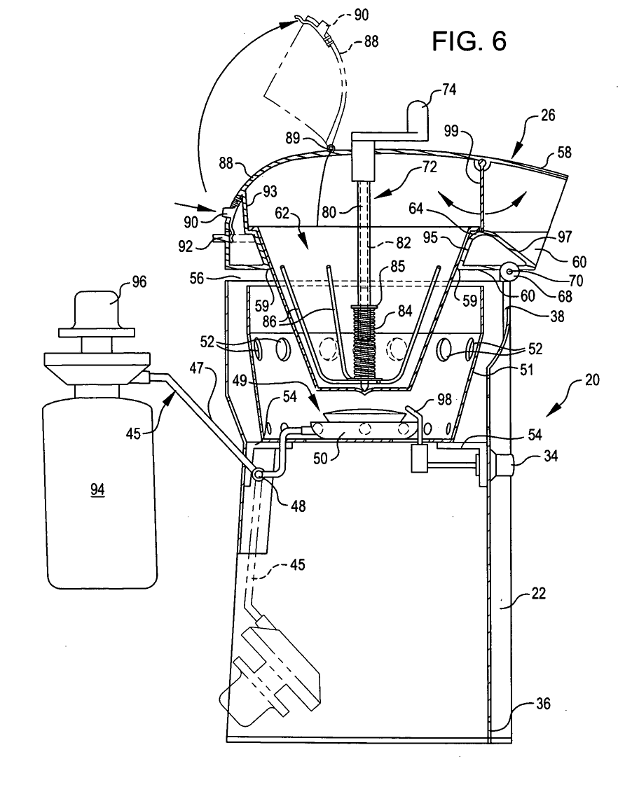

The chute 26 includes a chute top 58 and a chute bottom 60. The chute bottom 60 includes an opening 59 (e.g., FIG. 6) into which a cooking bowl 62 is mounted. The cooking bowl 62 is preferably formed with a thermally conductive metal, such as die-cast aluminum. A molded lip 64 (FIG. 6 only) may be provided around the outer edges of the opening 59 to prevent oil from dripping into the housing.

In the embodiment shown, the cooking bowl 62 includes a flat bottom to promote distribution of the popcorn kernels. As an alternative, the cooking bowl 62 may be rounded, such as in a half sphere shape, which provides greater distribution of heat and ease of manufacture. Other shapes may be used.

Eyelets 66 (FIG. 5) are located on the top of the upper housing 22. A second set of eyelets 68 are located on the bottom of the chute bottom 60. A hinge-pin 70 extends through both sets of eyelets 66, 68.

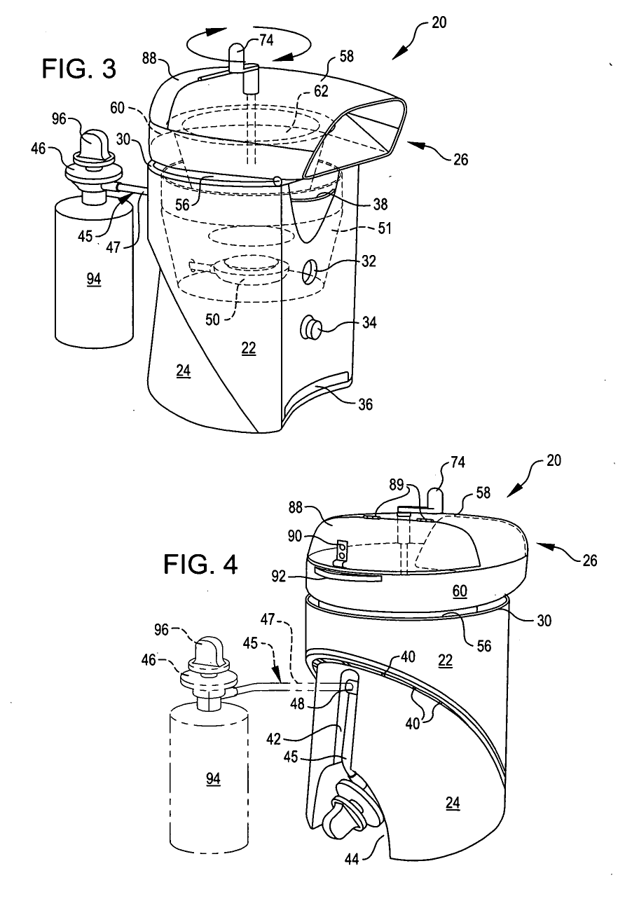

An agitator assembly 72 (best shown in FIG. 6) is attached to the chute top 58. The agitator assembly 72 includes a handle 74 that is rotatable about a hinge 76. In an embodiment shown in FIGS. 1 and 2, the handle 74 folds about the hinge 76 and stores in a slot 78 (FIG. 1) on the top of the chute top 58. Alternatively, the handle 74 may be fixed, such as is shown in FIGS. 3-8.

The agitator assembly 72 includes a tube 80 attached to a bottom part of the handle 74. A rod 82 is slidingly received within the tube 80. A spring 84 fits over the rod 82 and the tube 80 and is connected to a shoulder 85 on the tube 80 at one end, and to blades 86 at the opposite end. The blades 86 are connected to the rod 82 and are configured to extend along the bottom and sides of the cooking bowl 62. The connection of the spring 84 between the blades 86 and the shoulder 85 permits the blades 86 to move toward and away from the tube 80, with the movement being confined by sliding movement of the rod 82 within the tube 80.

A door 88 is mounted on the back of the chute top 58. The door 88 is hinged to the chute top 58 at hinges 89. A latch 90, such as a spring steel latch, is provided for holding the door 88 in position.

A tab 92 is positioned on the back of the chute bottom 60. The function of the tab 92 is described below.

Operation of the camping popcorn popper 20 will now be described. A user wishing to make popcorn gathers the camping popcorn popper 20, a propane bottle 94, popcorn kernels (not shown), and oil. Although the described embodiment utilizes propane for combustion, other fuels may be used, including, but not limited to, kerosene, gasoline, and other liquid, solid, or gaseous fuels.

When the camping popcorn popper 20 is stored, the regulator assembly 45 is positioned in the rear recess 44 and the rear slot 42 as is shown in FIG. 4. To use the camping popcorn popper 20, the regulator assembly 45 is folded out to the position shown in FIG. 1. The regulator 46 is then attached to the propane bottle 94.

The user pours oil and popcorn kernels into the cooking bowl 62. The door 88 provides easy access for the user to pour these items into the cooking bowl 62. The user then turns on the flow of gas from the propane bottle 94 to the burner 50, for example by a knob 96 on the regulator 46. The regulator drops the pressure of the fuel from the propane bottle 94 to a useable pressure for the burner 50. The regulator knob 96 is connected to a valve (not shown) so that rotation of the knob 96 increases or decreases the flow of fuel to the burner assembly 49. In an embodiment, the camping popcorn popper 20 is configured so that the regulator knob 96 is turned on full when popping corn, although other settings may be used. In an embodiment, the burner assembly supplies 5,000 BTU's of cooking power when the regulator knob 96 is on full.

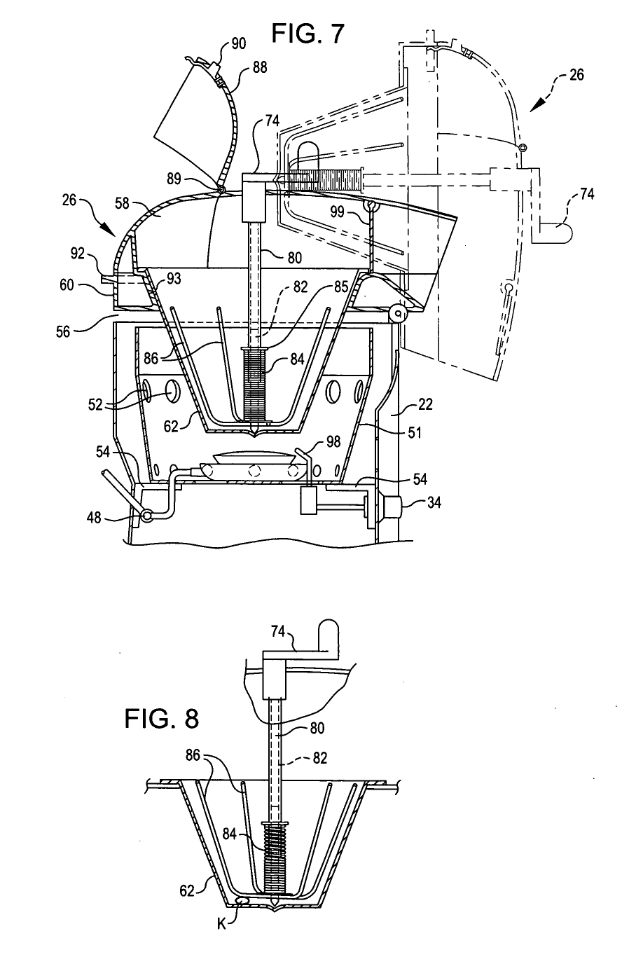

After the fuel flow is started, the user ignites the burner 50. For example, the user may press the electronic ignition button 34 to cause a spark at an igniter 98 (FIG. 7). Alternatively, the user may insert a lit match (not shown) into the view port/match hole 32. In either event, the user may view through the view port/match hole 32 to confirm that the burner 50 is lit.

As stated earlier, the various vents within the upper and lower housings 22, 24 provide sufficient air for continuous burning of the burner 50 as long as fuel is available. The burner 50 heats the bottom of the cooking bowl 62, and the oil and popcorn kernels therein.

The cooking bowl 62 eventually reaches a temperature at which the kernels being to pop, forming popped kernels. The popping popcorn flows out of the cooking bowl 62 and out of the chute 26 and into a container (not shown).

As the kernels start to pop, the user begins rotation of the handle 74, causing the agitator assembly 72 to rotate. The user may have to fold the handle 74 out of the slot 78 prior to rotation. In an embodiment, the user continues rotation of the handle 74 during the popping of the kernels. This rotation helps to stir kernels down to the bottom of the cooking bowl 62 so that they are heated to pop, and also helps the flow of popcorn out of the chute 26. In an alternate embodiment, the rotation of the agitator assembly 72 may be performed automatically, for example via a motor (not shown) powered by a battery (also not shown), by thermoelectric modules that are heated by the burner 50, or another suitable source.

In the embodiment shown in the drawings, the chute 26 includes a rear lower sloped surface 93 and a front lower sloped surface 95, both shaped and positioned to direct unpopped kernels back down into the cooking bowl 62. A leading lower sloped surface 97, forward of the front lower sloped surface 95, is provided to aid popped kernels in exiting the chute 26.

In the embodiment shown, a hinged panel 99 extends downward from the top of the chute 26. The hinged panel 99 aids in directing unpopped kernels back into the cooking bowl 62, but hinges upward to allow the passage of popped kernels. The front, top portion of the chute is also tapered downward toward the exit. This configuration, with or without the hinged panel 99, may be used to deflect unpopped kernels downward, limiting the potential of a hot unpopped kernel being projected from the front of the chute 26.

When the popping process is finished, the user may turn the regulator knob 96 to turn off the burner 50. The user may then grab the tab 92 and lift the rear part of the chute 26 upward, rotating the chute 26 around the hinge pin 70 to the position shown in phantom in FIG. 7. In this manner, any popped or un-popped kernels left in the chute 26 or the cooking bowl 62 are free to flow out of the chute 26 and into the container. If desired, while the chute 26 is in the upright position, the user may turn the handle 74, for example one rotation, so as to ensure all kernels and popped popcorn are dislodged from the cooking bowl 62.

If desired, the hinge pin 70 may be removed so that the chute 26 is removable from the camping popping popper 20. In this manner, the chute 26 and the cooking bowl 62 are easily cleaned. In an embodiment, the hinge pin 70 is removable without tools, for example being attached by a friction fitting, a cotter pin, or another suitable connection. In an embodiment, the chute top 58 disconnects from the chute bottom 60, making cleaning even easier. If desired, the components may be machine washable, providing ease of cleaning after use.

Because the blades 86 of the agitator assembly 72 are spring biased toward the bottom of the cooking bowl 62 but yet are free to travel against the bias of the spring toward the handle 74, the blades 86 may roll over kernels (e.g., K in FIG. 8) that are in the bottom of the cooking bowl 62. This feature permits the blades 86 to be mounted within the cooking bowl 62 without requiring exact tolerances between the two elements.

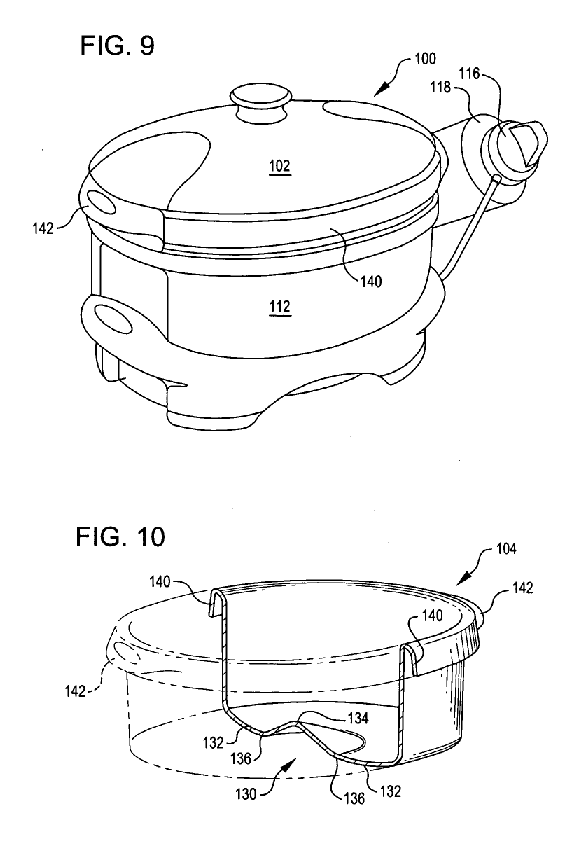

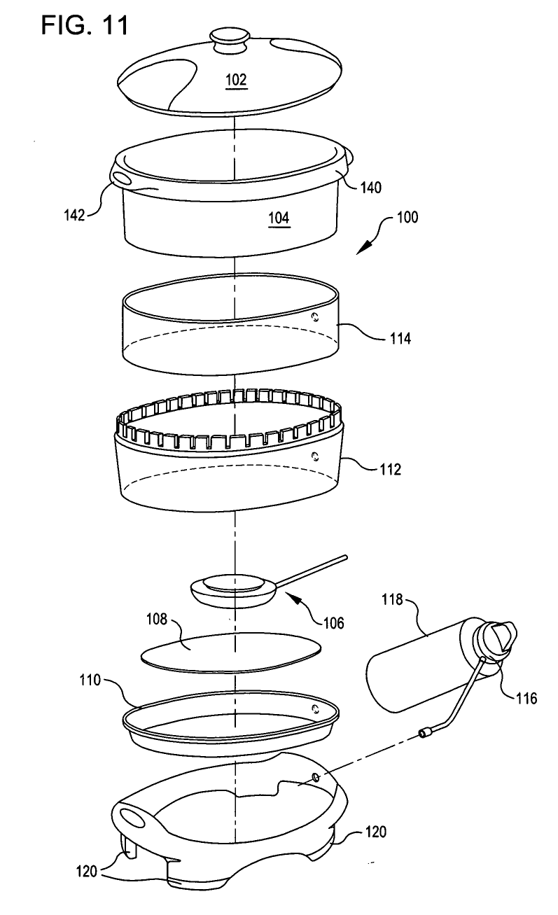

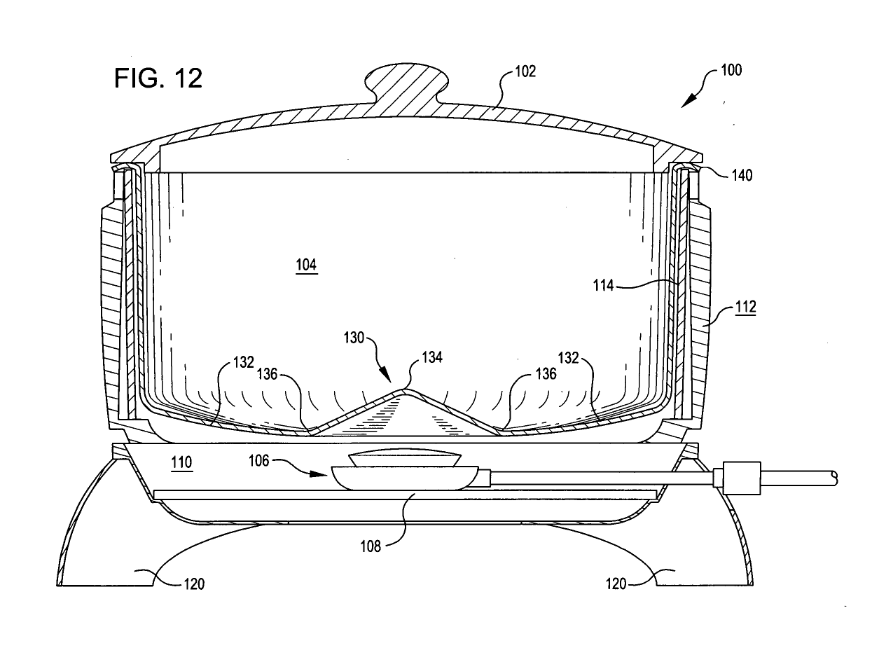

A second embodiment of a camping popcorn popper 100 is shown in FIGS. 9-12. As can be seen in FIG. 11, the camping popcorn popper 100 includes a lid 102 and a stewpot 104. As can be seen in FIG. 12, when assembled, a burner assembly 106 is positioned directly below the stewpot 104. A bottom heat shield 108 is positioned just below the burner assembly 106. The bottom heat shield 108 and the burner assembly 106 rest in a bottom pan 110. A bottom housing 112 rests on the periphery of the bottom pan 110, and extends upward therefrom. The bottom housing 112 includes a serrated upper edge for providing ventilation, as is further described below. A side heat shield 114 is positioned inside the bottom housing 112 between the stewpot 104 and the bottom housing 112.

A regulator assembly 116 attaches to the burner assembly 106. A propane bottle 118 is attached to the regulator assembly 116. The camping popcorn popper 100 includes feet 120 extending downward from the bottom pan 110, but a different base may be provided.

As can be seen in FIG. 10, the stewpot 104 includes an irregularly shaped bottom 130. The bottom 130 includes an outer portion 132 that slopes from the far outer edge down toward the center of the bottom 130. The bottom 130 also includes a high center 134. From the high center 134, the bottom 130 slopes downward to the inner edges of the outer portion 132.

With the outer portion 132 and the sloped sides extending downward from the high center 134 meeting together, a trough 136 is formed in the bottom of the bottom pan 110. In the embodiment shown in the drawings, the trough 136 is shaped in the form of a ring or circle. The circle may be concentric with the center of the bottom of the stewpot 104.

The trough 136 provides a benefit during the popping of popcorn. Specifically, in accordance with an embodiment, the burner assembly 106 is arranged so that flames extending upward from the burner impinge with the bottom 130 of the stewpot 104 at or near the bottom side of the trough 136. In this manner, the maximum amount of heat is supplied to this area. Moreover, the sloped sides of the outer portion 132 and the sides extending outward from the high center 134 direct popcorn kernels toward the bottom of the trough 136, where oil accumulates and the maximum heat is provided. In this manner, more kernels are popped.

If desired, the bottom 130 of the stewpot 104 may be arranged in a different manner so as to match the flame pattern of a particular burner. As an example, if a flame pattern is along a line, a trough may be provided that is linear instead of circular like the trough 136. Other arrangements may be provided.

In addition to being used as a popcorn popper, the stewpot 104 may be utilized for cooking of stews or other foods. The arrangement of the bottom housing 112, bottom pan 110, and side heat shield 114 provide good ventilation for a flame, but protection the burner assembly 106 from wind and other elements, such as rain. Specifically, the stewpot 104 includes an outer down-turned lip 140 that extends around and over the outside bottom housing 114. The serrated upper edge of the bottom housing 114 permits air to flow through this connection but the outer downward lip 140 protects rain from falling into the connection.

In the embodiment shown, the stewpot 104 includes handles 142 at opposite sides that allow it to be lifted directly out of the side heat shield 114 and the bottom housing 112. The stewpot 104 may therefore be used as a serving dish for popcorn, stew, or other items cooked in the stewpot.

Both of the camping popcorn poppers 20, 100 are fully portable and may be used with a disposable propane bottle. Thus, the units are easily used in family camping environments or for other outdoor activities.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A popcorn popper, comprising:
a housing;
a burner assembly for burning a fuel, the burner assembly being at least partly mounted within the housing;
a cooking pot for heating popcorn kernels and mounted above the burner assembly for heating by the burner assembly; and
a chute for directing popped popcorn kernels flowing out of the cooking pot away from the cooking pot.

2. The popcorn popper of claim 1, wherein the burner assembly is fully contained within the housing.

3. The popcorn popper of claim 2, wherein the housing includes upper and lower vents for permitting air flow to the burner assembly.

4. The popcorn popper of claim 3, wherein the housing is configured to serve as a wind block for the burner assembly.

5. The popcorn popper of claim 1, wherein in the cooking pot is mounted to the chute and the chute is rotatably connected to the housing so that the chute may be tilted to empty popped popcorn kernels out of the chute.

6. The popcorn popper of claim 1, further comprising a stirrer situated in the bottom of the cooking pot and designed to stir popcorn kernels within the cooking pot.

7. The popcorn popper of claim 6, wherein the stirrer is manually actuated.

8. The popcorn popper of claim 6, wherein the stirrer is battery powered.

9. The popcorn popper of claim 6, wherein the stirrer is powered by thermoelectric modules that are heated by the burner assembly.

10. The popcorn popper of claim 6, wherein the stirrer is mounted to the popcorn chute.

11. The popcorn popper of claim 6, wherein the stirrer is flexibly mounted in the cooking pot so that the stirrer is capable of moving to roll over a popcorn kernel in the cooking pot.

12. The popcorn popper of claim 1, further comprising a regulator assembly connected to the burner assembly, the regulator assembly for attaching to a fuel canister.

13. The popcorn popper of claim 12, wherein the regulator assembly is rotatably mounted to the housing, and wherein the housing includes a recess for receiving the regulator assembly in a stored state.

14. The popcorn popper of claim 1, wherein the chute is rotatably connected to the housing so that the chute may be tilted to empty popped popcorn kernels out of the chute.

15. The popcorn popper of claim 1, wherein in the cooking pot is mounted in the chute and the chute is removable from the housing without tools.

16. The popcorn popper of claim 1, wherein the chute comprises a door for the entry of popcorn kernels.

17. The popcorn popper of claim 1, wherein an exit portion of the chute is sloped downward from a middle portion of the chute toward the exit portion.

18. The popcorn popper of claim 1, further comprising a hinged door hanging downward from the top of the chute into the chute.

19. A popcorn popper, comprising:
a burner assembly for burning a fuel, the burner assembly having a flame pattern; and
a cooking pot for heating popcorn kernels and mounted above the burner assembly for heating by the burner assembly, the cooking pot including a trough along a bottom of the cooking pot, the trough aligned at least in part with the flame pattern of the burner assembly.

20. The popcorn popper of claim 19, wherein the trough is shaped as a circle.

21. The popcorn popper of claim 20, wherein the trough is concentric with a center of the bottom of the cooking pot.

22. The popcorn popper of claim 19, wherein the trough is substantially aligned with the flame pattern.

23. A cooking pot for heating popcorn kernels and configured to be mounted above a burner assembly having a flame pattern, the cooking pot including a trough along a bottom of the cooking pot, the trough being positioned so that when the cooking pot is placed over the burner assembly, the trough is aligned at least in part with the flame pattern of the burner assembly.

24. The popcorn popper of claim 23, wherein the trough is shaped as a circle.

25. The popcorn popper of claim 24, wherein the trough is concentric with a center of the bottom of the cooking pot.

26. The popcorn popper of claim 23, wherein the trough is substantially aligned with the flame pattern.
